(19) United States
(12) Patent Application Publication
(10) Pub. No.: US 2014/0327572 A1
(43) Pub. Date: Nov. 6, 2014

(54) WIRELESS POSITIONING TRACKER

(71) Applicant: ENNOCONN CORPORATION, New Taipei (TW)

(72) Inventor: MING-HSUEH TSAI, New Taipei (TW)

(73) Assignee: ENNOCONN CORPORATION, New Taipei (TW)

(21) Appl. No.: 14/262,910

(22) Filed: Apr. 28, 2014

(30) Foreign Application Priority Data
May 3, 2013 (TW) 102115843

(51) Int. Cl. G01S 19/01

(52) U.S. Cl. CPC G01S 19/01
USPC 342/357.39

(57) ABSTRACT

A wireless positioning tracker includes a communication unit, a function setting unit, a position tracking unit, and an alarm unit. The communication unit can communicate with external communication devices by human voice or by message. The function setting unit receives function commands from the external communication devices, for setting the wireless positioning tracker. The position tracking unit captures a current longitude and latitude of the wireless positioning tracker through a global positioning system unit for obtaining the current position. The past track of a moving object can be stored. The alarm unit can call for help from contact entities when the moving object presses a single alarm keystroke. The moving object may be monitored, tracked, and positioned by contact entities at all times.

### FIELD

The present disclosure relates to a wireless positioning tracker.

### BACKGROUND

Wireless positioning trackers are used to locate a moving object, based on a wireless communication with a global positioning system (GPS).

### BRIEF DESCRIPTION OF THE DRAWINGS

Many aspects of the present disclosure can be better understood with reference to the following drawing(s). The electronic components in the drawing(s) are not necessarily drawn to scale, the emphasis instead being placed upon clearly illustrating the principles of the present disclosure. Moreover, in the drawing(s), like reference numerals designate corresponding parts throughout the several views.

FIG. 1 is a diagrammatic view of a wireless positioning tracker of the embodiment, a moving object, an external communication system, and contact entities.

FIG. 2 is a block diagram of the wireless positioning tracker of FIG. 1.

FIG. 3 is a front diagrammatic view of the wireless positioning tracker of FIG. 1.

FIG. 4 is a rear diagrammatic view of the wireless positioning tracker of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.” The references “a plurality of” and “a number of” mean “at least two.”

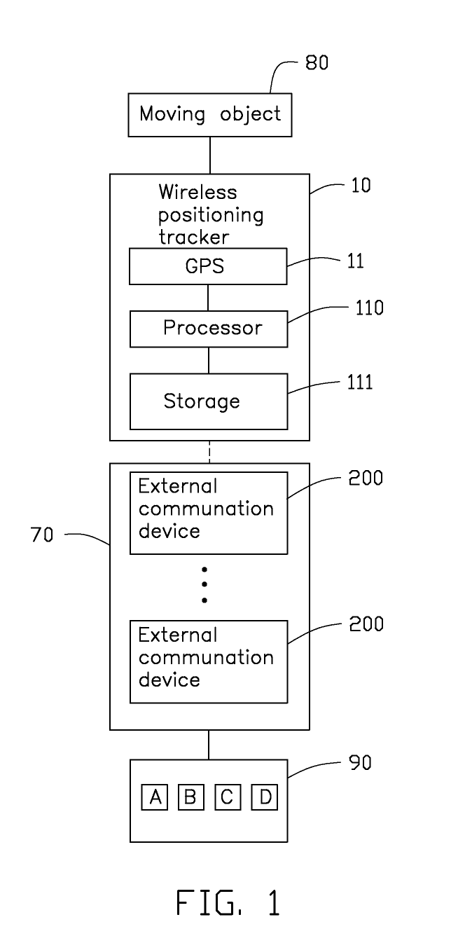

FIG. 1 illustrates an embodiment of a wireless positioning tracker 10 carried by a moving object 80 for communicating with an external communication system 70 to feed information of the moving object 80 back to one or more contact entities 90. The external communication system 70 includes a plurality of external communication devices 200, such as mobile telephones or computers. The wireless positioning tracker 10 includes a processor 110, a global positioning system (GPS) 11, and a storage 111 connected to the processor 110. The storage 111 stores a plurality of programs to be executed by the processor 110 to perform certain functions.

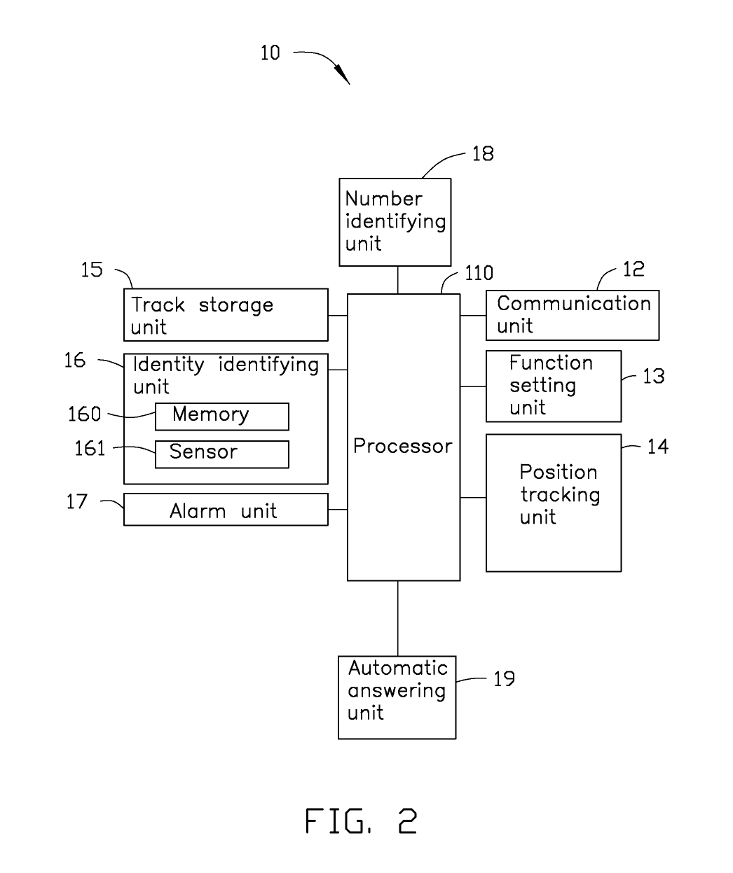

Referring to FIG. 2, the storage 111 can include a communication unit 12, a function setting unit 13, a position tracking unit 14, a track storage 15, an identity identifying unit 16, an alarm unit 17, a number identifying unit 18, and an automatic answering unit 19.

The wireless positioning tracker 10 includes a specific code provided by the communication operators. The communication unit 12 transmits two-way voice communications and messages with the external communication devices 200 according to the specific code.

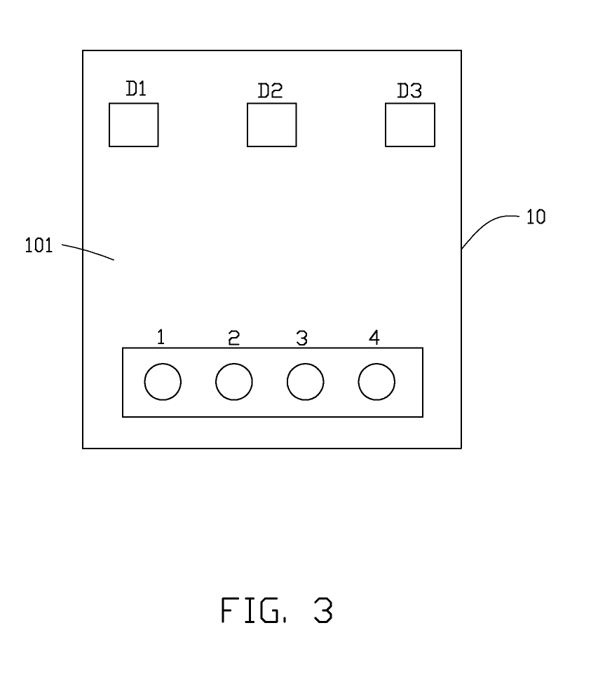

In FIG. 3, the wireless positioning tracker 10 includes a front surface 101 and a rear surface 102. Four buttons 1-4 are arranged on the front surface 101 of the wireless positioning tracker 10. In the embodiment, one of the external communication devices 200 sends function message commands to the processor 110. The processor 110 processes the function message commands received from the external communication devices 200, and transmits the function message commands to the function setting unit 13. Corresponding functions are set on the buttons 1-4 by the function setting unit 13, according to the function message commands.

In the embodiment, the buttons 1-3 function as communication keystrokes, corresponding to specific contact entities A, B, and C respectively. The button 4 functions as an alarm keystroke, a broadcast pointing to all of the special contact entities A-C of the contact entities 90. When the moving object 80 presses any one of the communication buttons 1-3 for a period of time, such as about two to three seconds, a corresponding contact entity is called to communicate, through the communication unit 12 controlled by the processor 110 of the wireless positioning tracker 10. When the moving object 80 presses the alarm keystroke 4 for about two to three seconds, all of the contact entities are given an alarm through the alarm unit 17 controlled by the processor 110 of the wireless positioning tracker 10, to indicate the moving object 80 is in danger.

The track storage 15 stores a past track of the wireless positioning tracker 10. When the wireless positioning tracker 10 receives a position inquiring message from one of the external communication devices 200, the position tracking unit 14 captures the longitude and latitude of the current location of the wireless positioning tracker 10 through the GPS 11, and transmits the current longitude and latitude to the communication unit 12. Then, the communication unit 12 transmits the current longitude and latitude of the wireless positioning tracker 10 to the corresponding external communication device 200.

Each of the current position and the past track of the moving object 80 can be transmitted to the contact entities 90 through the wireless network based on a general packet radio service (GPRS). Therefore, the contact entities 90 can obtain both the current position and a historical tracking of the moving object 80.

The identity identifying unit 16 includes a memory 160 and a sensor 161. The memory 160 storages a plurality of information of the moving object 80. The sensor 161 identifies the information of the moving object 80 with a radio frequency identification from a external identifier. Therefore, it is convenient for an organisation or group, such as school to check whether the moving object 80 is in fact a member of the organisation or group.

The number identifying unit 18 stores a plurality of telephone numbers of the contact entities 90. The moving object 80 can only answer a phone call from the plurality of telephone numbers (i.e. from a recognized telephone number), which prevents the moving object 80 communicating with non-recognized entities.

The automatic answering unit 19 can automatically answer phone call from a communication device of a primary contact entity D of the contact entities 90. In the embodiment, when the automatic answering unit 19 is operating, the wireless positioning tracker 10 does not call attention to the moving object 80 with a silent mode. The moving object 80 can not hang up the call from the primary contact entity D initiatively. Therefore, it is of benefit for the primary contact entity D to monitor the moving object 80 in real time.

FIG. 3 shows the wireless positioning tracker 10 which includes three status indication lights D1-D3 set on a front surface 101 of the wireless positioning tracker 10. The status indication lights D1-D3 indicate whether the wireless positioning tracker 10 is at low power status, transmitting a voice signal, and position recognition in contact with a GPS satellite respectively. When the wireless positioning tracker 10 is low battery power, the status indication light D1 is lit, warning that recharge of the wireless positioning tracker 10 is required. When the moving object 80 communicates vocally with a contact entity 90, the status indication light D2 is lit. When the wireless positioning tracker 10 is in a status of position recognition in contact with a GPS satellite, the status indication light D3 is lit.

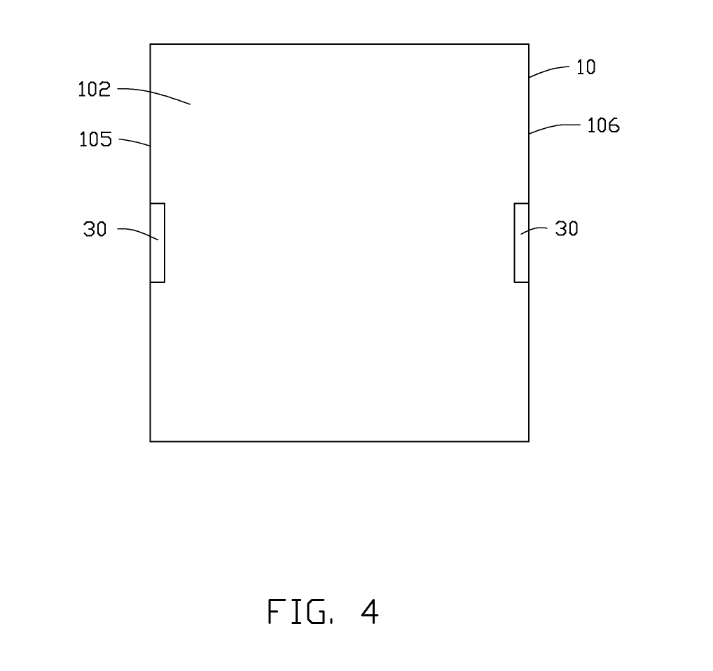

FIG. 4 shows the wireless positioning tracker 10 further including two card slots 30 disposed on two side walls 105 and 106 of the wireless positioning tracker 10. The card slots 30 can hold one or more of a plurality of cards, such as student cards, access cards, and bank cards. Carrying such cards conveniently is permitted by the tracker 10.

The wireless positioning tracker 10 may be used in a plurality of situations, such as by schools, in a hospital, a factory, a company situation, and an emporium. Therefore, the moving object 80 may be monitored, tracked, and positioned by at least one of the contact entities 90 through the wireless positioning tracker 10. Information concerning the moving object 80 may be reported timely to at least one contact entity 90.

While the disclosure has been described by way of example and in terms of a preferred embodiment, it is to be understood that the disclosure is not limited thereto. On the contrary, it is intended to cover various modifications and similar arrangements as would be apparent to those skilled in the art. The disclosed embodiments are illustrative only, and are not intended to limit the scope of the following claims.

What is claimed is:

1. A wireless positioning tracker, comprising:
a global positioning system (GPS);
a processor; and
a storage connected to the processor, wherein the storage stores a plurality of programs to be executed by the processor to perform certain functions, storage including:
a communication unit transmitting voice signals and messages through a plurality of external communication devices used by a plurality of contact entities;
a function setting unit receiving function commands from the external communication devices, for setting functions;
a position tracking unit capturing current longitude and current latitude of the wireless positioning tracker through the GPS, for obtaining a current position and a past track of a moving object; and
an alarm unit calling help to contact entities when the moving object in danger.

2. The wireless positioning tracker of claim 1, further comprising a specific code, and wherein the communication unit transmits voice communications and messages with external communication devices according to the specific code.

3. The wireless positioning tracker of claim 1, further comprising a plurality of buttons, each of the buttons is set a function through the function setting unit, according to the function commands from the external communication devices.

4. The wireless positioning tracker of claim 3, wherein the plurality of buttons comprises an alarm keystroke, the moving object calls help to contact entities through pressing the alarm keystroke when in danger.

5. The wireless positioning tracker of claim 1, further comprising an automatic answering unit, the automatic answering unit automatically answers call from a communication device of a primary contact entity.

6. The wireless positioning tracker of claim 1, wherein each of the plurality of buttons is set to point each of a plurality of special contact entities respectively, through the function setting unit, to make the moving object calling the special contact entities.

7. The wireless positioning tracker of claim 6, wherein a current position of the moving object is sent to the all of the special contact entities through the alarm unit, when the alarm keystroke is pressed by the moving object.

8. The wireless positioning tracker of claim 7, wherein when the position tracking unit receives a location request message from one of the external communication devices, the current longitude and latitude of the location tracker is transmitted to the external communication device in a form of message, through the communication unit by the position tracking unit.

9. The wireless positioning tracker of claim 8, further comprising a track storage, wherein a historical track of the moving object is stored by the track storage, to make the historical track of the moving object is acquired by the contact entities through a wireless network.

10. The wireless positioning tracker of claim 9, further comprising a number identifying unit, wherein the number identifying unit stores a plurality of telephone numbers of the contact entities, to be automatically answered by the moving object.

11. The wireless positioning tracker of claim 10, further comprising an identity identifying unit storing a plurality of information of the moving object, wherein the identity identifying unit senses a radio frequency identification from an external identifier.

12. The wireless positioning tracker of claim 1, further comprising three status indication lights, for indicating whether the wireless positioning tracker is in the status of no power, transmitting voice signal, and positioning respectively.

13. The wireless positioning tracker of claim 1, further comprising two card slots disposed on two side walls of the wireless positioning tracker.
